(19) United States
(12) Patent Application Publication
(10) Pub. No.: US 2015/0139655 A1
(43) Pub. Date: May 21, 2015

(54) INFRARED CONTROL SYSTEM AND INFRARED CONTROL METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHAN-JIA AO, Wuhan (CN); JIAN-HUNG HUNG, New Taipei (TW)

(21) Appl. No.: 14/497,905

(22) Filed: Sep. 26, 2014

(30) Foreign Application Priority Data
Nov. 19, 2013 (CN) 2013105771951

(51) Int. Cl. G08C 23/02

(52) U.S. Cl. CPC G08C 23/02
USPC 398/112

(57) ABSTRACT

An infrared control system includes one or more target terminal assemblies, a control device, and an infrared controller which creates a coupling between a terminal assembly and the control device. The terminal assembly includes a plurality of terminals which recognize infrared signals. The control device includes a setting module used to set parameters of each terminal assembly. The parameters include an Identification of Position (IP) of a working terminal in a predetermined time. The infrared controller can open a particular terminal according to the parameters which are set. The disclosure further provides an infrared control method.

### FIELD

The present disclosure relates to infrared control systems.

### BACKGROUND

Usually, an electronic device needs a matching remote control device to control the electronic device. The electronic device can be an air-conditioner, a refrigerator, a television, so the air-conditioner, the refrigerator, and the television need three remote control devices.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagrammatic view of an embodiment of an infrared control system.

FIG. 2 is a block diagram of one embodiment of function modules of the infrared control system.

FIG. 3 is a flowchart of one embodiment of an infrared control method using the infrared control system of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure describes an infrared control system comprising a terminal assembly, a control device, and an infrared controller coupled to the terminal assembly and the control device. The terminal assembly comprises a plurality of terminals. The control device comprises a setting module used to set parameters of the terminal assembly. The parameters can comprise an Identification of Position (IP) of a working terminal in a predetermined time. The infrared controller is used to open a terminal according to the parameters.

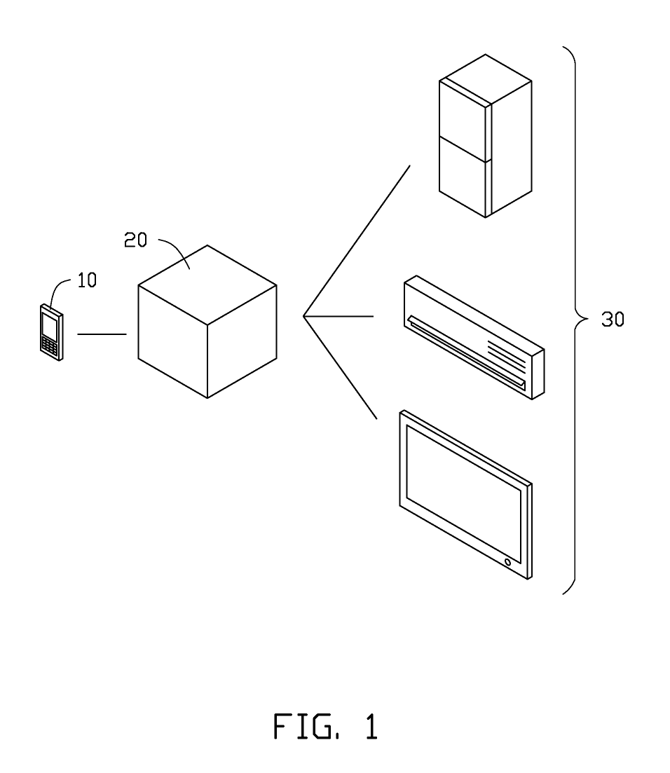

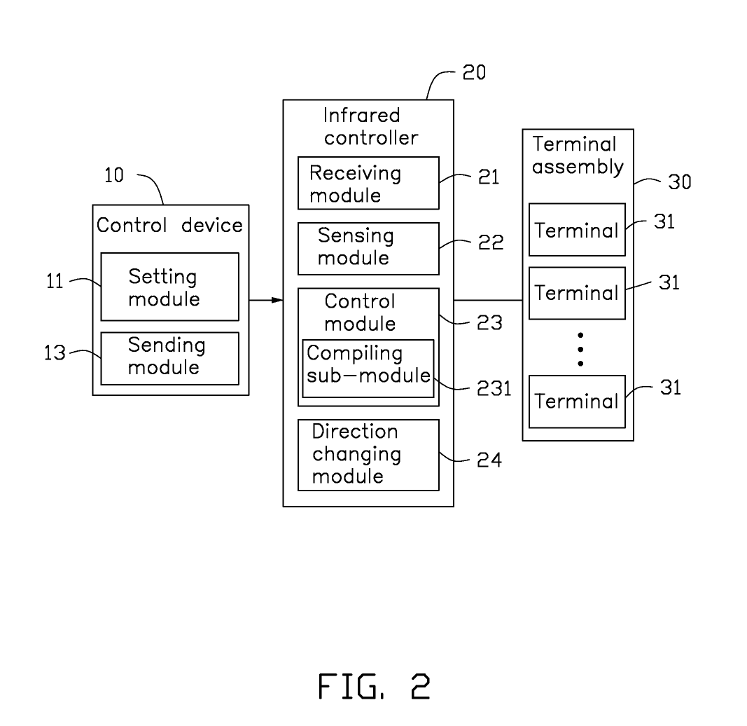

FIGS. 1-2 illustrate an embodiment of an infrared control system. The infrared control system can comprise a control device 10, an infrared controller 20, and a terminal assembly 30. The control device 10 can communicate with each of the terminal assemblies 30 through the infrared controller 20. In at least one embodiment, the control device 10 can be a mobile phone, a notebook, or a tablet computer. The terminal assembly 30 comprises a plurality of terminals 31 having an infrared-recognizing function. The plurality of terminals 31 can be an air-conditioner, a refrigerator, a television, or other controllable device.

The control device 10 comprises a setting module 11 and a sending module 13. The setting module 11 is used to set parameters of the terminal assembly 30. In at least one embodiment, the parameters can comprise an Identification of Position (IP) of at least one working terminal in a predetermined time, for example, between nineteen hundred hours to twenty-one hundred hours, two of the plurality of terminal assemblies 30, such as the television and the air-condition, are working Between nineteen hundred hours to twenty-four hundred hours, one of the plurality of terminal assemblies 30, such as the air-conditioner, is working. The refrigerator is regarded as working twenty-four hours a day. The sending module 13 is configured to send the parameters to the infrared controller 20.

The infrared controller 20 can comprise a receiving module 21, a sensing module 22, a control module 23, and a direction changing module 24. The direction changing module 24 is used to align the infrared controller 20 with a particular terminal which is currently inactive. The receiving module 21 is used to receive the parameters from the sending module 13. The sensing module 22 is used to sense a current environment index number to send to the control module 23. The environment index number can be a combination of a current temperature value and a current humidity value. After receiving the environment index number, the control module 23 is used to control the direction changing module 24 to align infrared controller 20 with a particular terminal 31 to activate the particular terminal 31. The control module 23 further comprises a compiling sub-module 231 used to compile one or more predetermined ranges of parameter values. The predetermined ranges of parameter values comprise a temperature range value and a humidity range value. For example, the predetermined temperature range value can be a range between 24° C. and 27° C., and the predetermined humidity range value can be a range between 50 percent and 60 percent. When the sensing module 22 senses that the current environment index number is not within the predetermined range of values, for example, the current temperature value is not within the predetermined range of temperature values, or the current humidity value is not within the predetermined range of humidity values, the control module 23 is used to control the direction changing module 24 to align infrared controller 20 with the particular terminal to adjust the current temperature value or the current humidity value. For example, when the sensing module 22 senses the current temperature value is 21° C. or 29° C., the control module 23 controls the direction changing module 24 to align infrared controller 20 with the terminal assembly 30 to adjust the current temperature value so as to be within the predetermined range of 24 degrees to 27 degrees. When the sensing module 22 senses that the current humidity value is 45 percent or 65 percent, the control module 23 controls the direction changing module 24 to align infrared controller 20 with the particular terminal to adjust the current humidity value to be within the predetermined range of between 50 percent and 60 percent humidity.

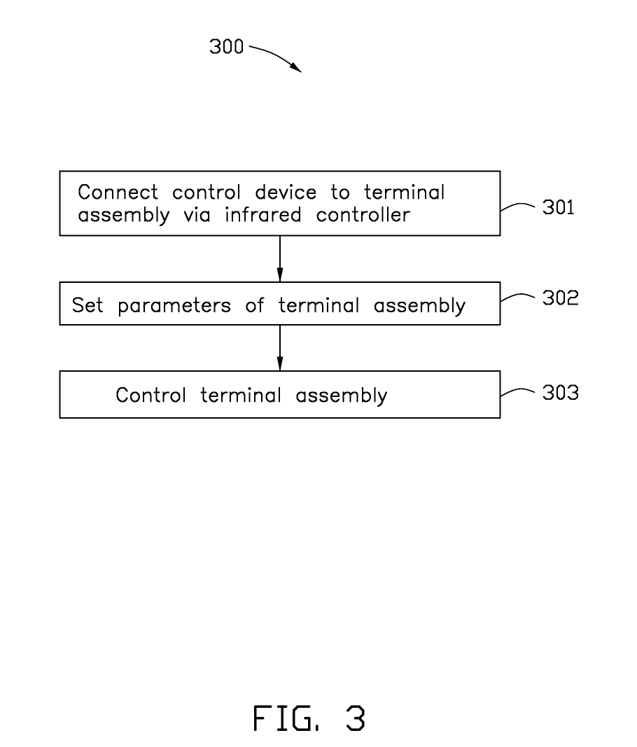

FIG. 3 illustrates a flowchart in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining the example method. Each block shown in FIG. 3 represents one or more processes, methods, or subroutines, carried out in the exemplary method 300. Additionally, the illustrated order of blocks is by example only and the order of the blocks can change. The exemplary method 300 can begin at block 301.

In block 301, the control device 10 is in communication with the terminal assembly 30 via the infrared controller 20.

In block 302, the setting module 11 sets the parameters of the terminal assembly 30. The parameter comprises an Identification of Position (IP) of at least one working terminal assembly in a predetermined time.

In block 303, the control module 23 controls each terminal 31 in the terminal assembly 30. For example, the control module 23 controls the direction changing module 24 to align infrared controller 20 with a particular terminal 31 to activate the terminal 31. When the sensing module 22 senses that the current temperature value is not within the predetermined temperature range, the control module 23 controls the direction changing module 24 to align infrared controller 20 with the particular terminal to adjust the current temperature value to between 24° C. and 27° C. When the sensing module 22 senses that the current humidity value is not within the predetermined humidity range value, the control module 23 controls the direction changing module 24 to align infrared controller 20 with the particular terminal to adjust the current humidity value to be within the range of between 50 percent and 60 percent humidity.

The embodiments shown and described above are only examples. Many details are often found in the art such as the other features of the circuit board. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An infrared control system comprising:
a terminal assembly having a plurality of terminals;
a control device comprising a setting module configured to set parameters of the terminal assembly, the parameters including an Identification of Position (IP) of at least one working terminal from the plurality of terminals in a predetermined time; and
an infrared controller coupled to the terminal assembly and the control device, the infrared controller configured to open a terminal corresponding to the at least one working terminal according to the parameters of the working terminal.

2. The infrared control system of claim 1, wherein the control device further comprises a sending module, the infrared controller comprises a receiving module, and the sending module is configured to send the parameters to the receiving module.

3. The infrared control system of claim 1, wherein the infrared controller further comprises a sensing module configured to sense a current environment index number, the control device further comprising a control module, and the control module is configured to control the terminal assembly after the current environment index number is determined as outside a predetermined range of parameter values.

4. The infrared control system of claim 3, wherein the control module comprises a compiling sub-module configured to compile the predetermined parameter range value.

5. The infrared control system of claim 3, wherein the infrared controller further comprises a direction changing module, and the direction change module is configured to align the infrared controller with the corresponding terminal after the current environment index number is determined as outside the predetermined range of parameter value.

6. The infrared control system of claim 3, wherein the predetermined parameter range value comprises a predetermined range of temperature values, the sensing module is configured to sense a current temperature value, and the control module is configured to control the corresponding terminal to be within the predetermined range of temperature values when the current temperature value is not within the predetermined range of temperature values.

7. The infrared control system of claim 3, wherein the predetermined range of parameter values further comprises a predetermined range of humidity values, the sensing module is configured to sense a current humidity value, and the control module is configured to control the corresponding terminal be in the predetermined range of humidity values when the current humidity value is not within the predetermined range of humidity values.

8. The infrared control system of claim 1, wherein the plurality of terminals comprises an air-conditioner, a refrigerator, and a television.

9. An infrared control method comprising:
connecting a terminal assembly and the control device by an infrared controller, the terminal assembly comprising a plurality of terminals;
setting parameters of the terminal assembly by a setting module of the control device, the parameters comprising an Identification of Position (IP) of a working terminal in a predetermined time; and
opening a corresponding terminal according to the parameters by the infrared controller.

10. The infrared control method of claim 9, further comprising sending the parameters to a receiving module of the infrared controller by a sending module of the control device before opening the corresponding terminal according to the parameters by the infrared controller.

11. The infrared control method of claim 9, further comprising sensing a current environment index number by a sensing module of the infrared controller; and controlling the terminal assembly by a control module of the infrared controller after the current environment index number is determined as outside a predetermined range of parameter values.

12. The infrared control method of claim 11, further comprising compiling the predetermined range of parameter values by the compiling sub-module.

13. The infrared control method of claim 11, further comprising aligning the infrared controller with the corresponding terminal by a direction changing module of the infrared controller after the current environment index number is determined as outside the predetermined range of parameter values.

14. The infrared control method of claim 11, wherein the predetermined range of parameter values comprises a predetermined range of temperature values, and the infrared control method further comprises sensing a current temperature value by the sensing module and control the corresponding terminal be in the predetermined range of temperature values by the control module when the current temperature value is not within the predetermined range of temperature values.

15. The infrared control method of claim 11, wherein the predetermined range of parameter values comprises a predetermined range of humidity values, and the infrared control method further comprises sensing a current humidity value by the sensing module and control the corresponding terminal be in the predetermined range of humidity values by the control module when the current humidity value is not within the predetermined range of humidity values.

16. The infrared control method of claim 9, wherein the plurality of terminals comprises an air-conditioner, a refrigerator, and a television.
